(19) United States
(12) Patent Application Publication
(10) Pub. No.: US 2010/0017242 A1
(43) Pub. Date: Jan. 21, 2010

(54) POWER STANDARD COMPLIANCE METHOD AND SYSTEM

(75) Inventors: Rick A. Hamilton, II, Charlottesville, VA (US); Brian M. O'Connell, Cary, NC (US); Clifford A. Pickover, Yorktown Heights, NY (US); Keith R. Walker, Austin, TX (US); Robert Wisniewski, Ossining, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/173,419

(22) Filed: Jul. 15, 2008

(51) Int. Cl. G06Q 10/00

(52) U.S. Cl. 705/8; 705/7

(57) ABSTRACT

Methods, systems, devices and program products are provided for effecting compliance with power usage specifications through positive feedback to a monitoring entity. A power usage specification is provided for a device for a task performed by the device using the device to perform the task, embodiments monitoring power used by the device to perform the task to generate power usage data, comparing the power usage data to the power usage specification, and if the power usage data exceeds the power usage specification, automatically providing a reward to a device end-user selected as a function of a value of the specification exceeding and an agreement with the end-user or a third party. Power usage specifications may comprise predicted power usage values and requirements for the device to perform the task during a first power rate period having a lower energy or resource cost than a second power rate period.

### FIELD OF THE INVENTION

The present invention generally describes methods, systems and devices for monitoring power usage in devices and effecting compliance with specification power usage limits, and more particularly through effecting compliance with limits and other standards by positive feedback mechanisms, including rewarding monitoring and reporting users.

### BACKGROUND OF THE INVENTION

Green computing has been defined as the study and practice of using computing resources efficiently. Technological systems, computing products, programmable devices (for example, computers, personal digital assistants (PDA's), smart phones, video gaming devices, etc.) and associated powered accessories (displays, printers, routers, switches, etc.) may incorporate green computing principles by taking into account economic viability, social responsibility and environmental impact. In particular, green computing includes efforts to obtain maximized energy and resource efficiency from the computer resources being used, and in one aspect to reduce associated waste and negative environmental impacts. Green computing may also be described as the science behind efficient computing and performing tasks on a smaller power budget. Similar policies and concerns also apply to non-computing appliances and other devices, for example including refrigerators, microwave ovens, dishwashers, hot water heaters.

Manufacturers of appliances and other devices may disclose amounts of expected energy usage by the device, in one aspect to influence consumers' electronic device purchases by predicted energy consumption. For example, the United States (US) Environmental Protection Agency (EPA) administers an Energy Star program wherein computing and other powered appliances and devices are to be rated for energy usage for specified tasks and compared to other similar devices, and wherein they may also be labeled as meeting certain energy efficiency guidelines. One intention of this and other programs is to inform consumers and other end users of predicted energy usage by rated devices for common tasks relative to competing products, and thereby encourage and enable consumers/end users to make energy-efficient choice between two rated devices in consideration of realizing direct cost savings and/or environmental impact reductions.

Additionally, energy costs as well as greenhouse gas emissions generated by energy usage may be dependent upon temporal and source parameters. For example, energy available from green or renewable sourcing may be dependent upon source inputs: energy from wind power generators may depend upon minimum wind speeds, the quality of solar cell source sunlight may depend on weather conditions (e.g. sunny days) or seasonal peaks in sunlight intensity, and biomass generating sources may depend on fluctuating availability of biomass fuel inputs, as well as other necessary inputs (e.g. water). Public utilities may also experience peak demand periods that require the acquisition of more expensive or less greenhouse gas-efficient energy from less-preferred sources in order to meet demands, and it is known for utilities to charge variable rates for energy over different time periods, charging higher rates in order to discourage use during peak demand periods, and lower rates during other epochs, thereby encouraging users to shift their tasks to other non-peak times when energy costs less, or may be satisfied by greener sources such as wind, solar or biomass.

However, it is not easy for consumers and end users to verify whether a given device actually complies with promised or required energy restrictions and efficiencies, or enforce the standards specifying the same. If a device does in fact fail to meet a promised or required energy efficiency or temporal or source-dependent standard, the consumer suffers a loss with respect to the cost of unexpected energy consumption, the environment suffers from the generation of additional emissions required to produce the extra energy, and the manufacturer is wrongly rewarded with profits through the sales of devices that would not have been purchased had the actual power usage performance been known by wholesalers, consumers, end users, governmental regulators, etc.

Thus, there is a need for improved methods and systems that address the above problems, as well as others.

### SUMMARY OF THE INVENTION

Methods are provided for effecting compliance with power usage specifications through positive feedback to a monitoring entity, comprising providing a power usage specification for a device for a task performed by the device; using the device to perform the task; monitoring power used by the device to perform the task to generate power usage data; comparing the power usage data to the power usage specification; and if the power usage data exceeds the power usage specification, a reward entity automatically providing a reward to a device end-user selected as a function of a value of the specification exceeding and an agreement with the end-user or a third party.

Some methods comprise predicted power usage value power usage specifications for the device to perform the task, monitoring comprising observing an actual power usage of the device required to perform the task, the power usage data exceeding the power usage specification comprising the observed actual power usage exceeding the predicted power usage value. Methods also comprise power usage specifications comprising a requirement for the device to perform the task during a first power rate period, the first power rate period having a lower energy or resource cost than a second power rate period, the monitoring comprising observing the device performing the task within a one of the first rate period and the second rate period, and the power usage data exceeding the power usage specification comprising observing the device performing the task during the second rate period.

In another aspect, service methods are provided comprising deploying applications for effecting compliance with power usage specifications through positive feedback to a monitoring entity according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for effecting compliance with power usage specifications through positive feedback to a monitoring entity. Moreover, systems, articles and programmable devices configured for performing one or more method and/or process elements of the current invention as also provided for effecting compliance with power usage specifications through positive feedback to a monitoring entity, for example as described above, are also provided.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a method and system for effecting compliance with power usage specifications through positive feedback to a monitoring entity according to the present application.

FIG. 2 is a block diagram of a system or device configured to provide energy usage monitoring according to the present application.

FIG. 3 is a block diagram of an implementation of a system or device configured to provide energy usage monitoring according to the present application.

FIG. 4 is a block diagram illustrating a computerized device implementation of a method and system for effecting compliance with power usage specifications through positive feedback to a monitoring entity according to the present application.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

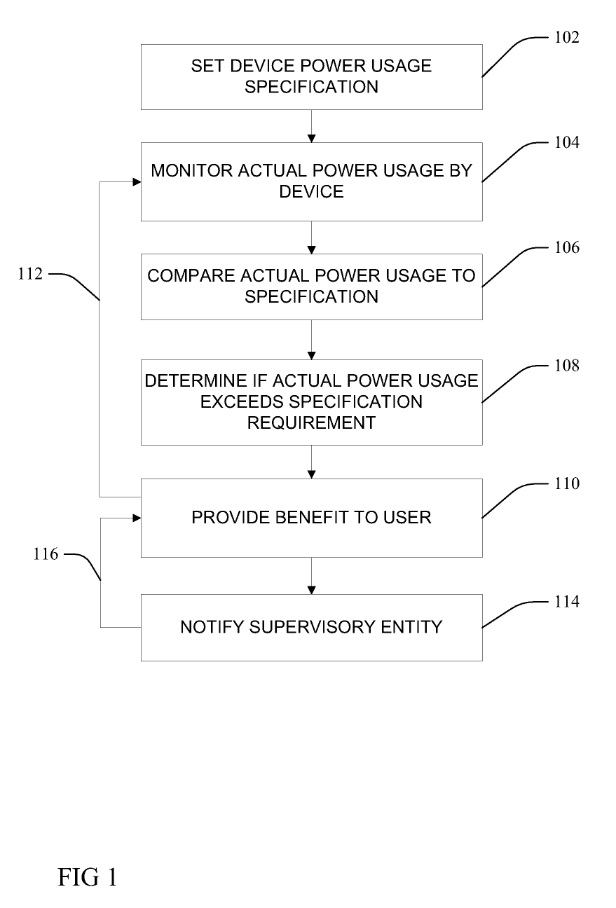

The present application discloses systems, methods, devices and program products for effecting compliance with power usage specifications through positive feedback to a monitoring entity. Referring now to FIG. 1, at 102 one or more power usage specifications are provided for a device. For example, a manufacturer may ascertain the expected power usage requirement for a given task performed by the device (e.g. power usage required to print a 10 page text document by a printer, or power usage required to wash a load of dishes under a normal setting at a given water temperature by a dishwasher, and other examples will be apparent to one skilled in the art). The power requirement, as well as means for determining compliance with a power requirement specification, may be specified by third-party entities such as a governmental regulatory authority or an industry testing organization.

A power usage specification at 102 may also comprise temporal or source-dependent energy use and associated task scheduling. For example, it is known for utilities and other power-provider entities to bill at different rates depending on the time of day and present demand (e.g. peak or non-peak), as well as a function of the availability of green sourcing such as solar, wind generators, etc. Accordingly, a power usage specification may enable a powered device to selectively schedule or otherwise perform a task to take advantage of low cost, low impact or other specified or identified time periods or energy sourcing opportunities, for example as a function of utility rate schedules or other power provider data and inputs.

At 104 actual operating power usage by the device in accomplishing a given task as operated by a consumer or other end-user is monitored and data is generated by the monitoring for use in determining compliance with the one or more power usage specifications provided at 102. At 106 power usage data is compared to the one or more specifications, and at 108 it is determined if the observed and monitored power usage exceeds one or more specification requirements provided at 102. If so, then at 110 the device end-user operating the device receives a benefit, rewarding the end-user as a function of the monitoring at 104, for example through reporting monitored power usage exceeding one or more of specification requirements. In one aspect, a positive feedback looping mechanism relationship 112 may be provided with the monitoring at 104 in order to encourage continuous and additional monitoring by the end-user, for example by increasing an amount or frequency of reward or benefit bestowed upon the end-user as a function of a duration of monitoring or a number of specification-exceeding observations monitored and reported while the device is being operated by the monitored device through operation and supervision by the end-user.

Notification of device power usage profiles relative to the one or more power usage specifications provided at 102 may be provided to a supervisory or third-party entity at 114 (for example, including the device manufacturer, a governmental agency or regulatory body, an industry certification organization, etc.). In one aspect, providing such notification may incorporate a positive feedback looping mechanism relationship 116, provided with the monitoring at 104 in order to encourage continuous and additional notifications by the monitored device through operation and supervision by the end-user.

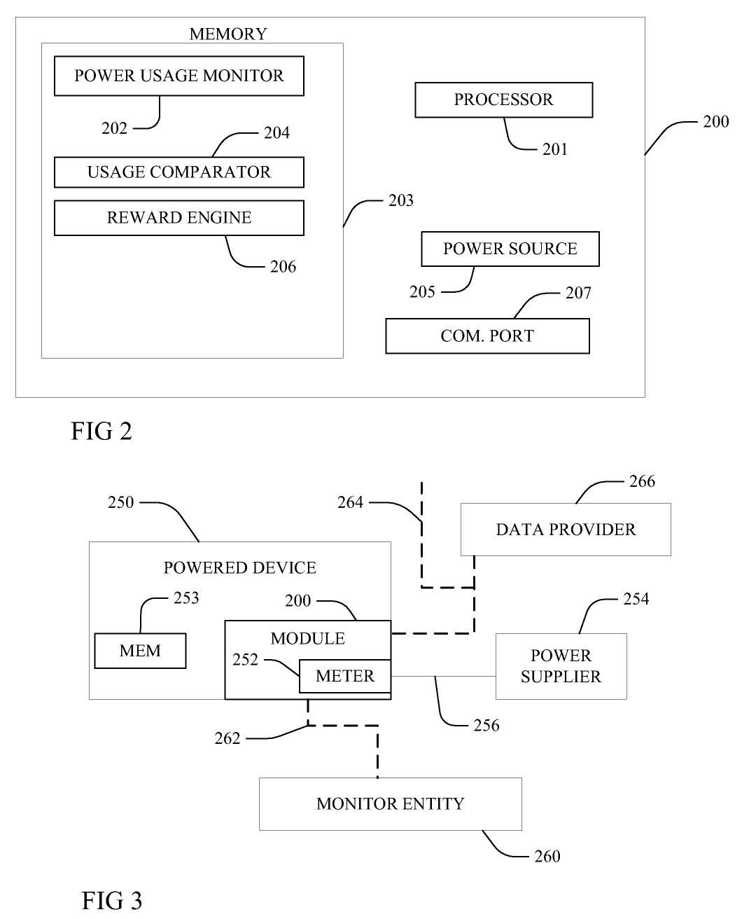

FIG. 2 illustrates a programmable device or module 200 configured to monitor power usage and communicated with a monitoring or reward entity according to the present application. The module 200 comprises a central processing unit (CPU) or other processing means 201 in communication with a memory 203, the memory 203 comprising logic components that enable the CPU 201 to perform processes and methods according to the present application. In the present embodiment, the memory 203 comprises a power usage monitor logic component 202, a usage comparator logic component 204 and a reward engine logic component 206, which may be understood by reference to the processes and methods illustrated in FIG. 1 and described above, and other embodiments may incorporate divergent logic components. A power unit 205 is configured to provide operative power to the module 200; examples include battery units 205 and power inputs configured to receive alternating or direct current electrical power, and other appropriate power units 205 will be apparent to one skilled in the art. A communication port or network link/node means 207 is also provided and configured to enable network and other communications with monitoring and reward entities, as well as others as appropriate.

Measurement and monitoring of power usage by a powered device at 104 may be accomplished by components of the device itself, or by an external means such as the module 200 (FIG. 2), a computer or other programmable appliance in communication with the powered device. More particularly, FIG. 3 illustrates an implementation of the module 200 (FIG. 2) configured to monitor energy usage as provided by a power supplier 254 to a powered device 250 configured to operate pursuant to one or more power usage specifications. In the present example the module 200 further comprises a power meter 252: in some embodiments the meter 252 is incorporated within the module 200 or powered device 250, and in others the meter 252 is a plug-in type placed in-line in a power supply circuit connection 256 between the powered device 250 and a source of power 254 and thereby situated to monitor and measure power flowing from the power source 254 into the powered device 250. Power modules 200 and associated meters 252 may be placed in or used with common household appliances 250 such as a refrigerators, washers, razors, dryers, ovens, furnaces, air conditioners, etc., or in computer or computing devices 250, such as external disk drives, network switches, network routers, tape drives, etc.

The power module 200 is configured to receive inputs from the meter 252 to thereby monitor and report observed device 250 power consumption, in some examples purporting at regular or defined intervals to a third party 260 such as a central bureau through a communication means 262. In some embodiments, the monitor/central bureau 260 may apply a local table of acceptable values (for example one provided by the manufacturer), wherein the bureau 260 may note and report only violations of the acceptable power usage standard values. For example, a dishwasher 250 may be enabled to defer washing a load of dishes until a late-night or other non-peak time period in response to utility provider scheduling information provided in the table, and accordingly the module 200 may be configured to verify a correlation of a user-requested dishwashing task to a non-peak-rate utility period. In some embodiments, the table may be stored in the module memory 203 or within a memory means 253 incorporated within the powered device 250 and in communication with the module 200, the module 200 thereby configured to track device 250 power consumption and to locally compare power device 250 consumption to stored table specifications.

In some embodiments, a power usage specification may include a device 250 configuration enabling the device to communicate directly through a connection means 264 with other devices/systems, power provider or governmental or regulatory entities to acquire current and/or projected costs of electricity and thus select a most efficient or preferred time for operation, or to update table information or power usage specifications (for example as stored in one of the memories 203/253). A programmable device 250, such as computer system or associated peripheral device or a smart/programmable appliance, may also be configured to schedule or perform a requested task at a time chosen in response to real-time or dynamically variable data and inputs provide through the communication means 264, for example deferring a large non-time sensitive print job until a non-peak rate or green source availability is indicated by a signal or other input from a utility 254 or another power provider or governmental regulatory entity 266.

In some embodiments, the modules 200 and/or associated meters 252 may incorporate Number In a Can (NIC) electronic chip and digital clock devices known to keep reasonably accurate time, providing an ability to monitor appliance 250 power usage as well as providing unique identification number indicia useful for identifying the module 200 as well as the monitored powered device 250.

The communication means 262 and 264 may configured to provide for robust data security, in one aspect to keep powered device 250 identity and performance data communicated there through confidential and secure from divulgation to other unauthorized parties. For example, a universally unique number identifying the powered device may be generated or assigned for use in identification and communication, and some device 250 or module 200 hardware embodiments may directly incorporate NIC components, for example mounted on a circuit board incorporated within the powered device 250 or module 200 and containing unique identification information such as a serial number of the circuit board, model and serial number of the powered device 250, date of assembly or manufacture, etc. Secure communication channels may also be established, in order to prevent unauthorized parties from intercepting communications and gleaning private or confidential information about the operating end-user or the device manufacturer.

Power meter consumption observations may also be analyzed for methods to reduce the power consumption of a powered device 250. If a device configuration revision is determined to improve power usage of the device 250 in performing a given task, the revision may be communicated to the operating end-user as a form of positive feedback benefit and implementable by the end-user, or a device configuration revision may be automatically and directly implemented in the device 250 through inputs received through one of the secure communication means 262/264, for example in the background unknown to the end-user or otherwise not requiring any affirmative action by an end-user. Analyzing may encompass a variety of methods and processes as well as incorporating additional information; for example, power consumption from time periods before and after an energy violation is reported may be analyzed, as well as reported power consumptions from other similar or relevant power devices, in order to identify opportunities for reducing power usage below one or more specifications. Device filtering may also be incorporated to decrease the amount of data transmitted to a collecting bureau 260, which may be advantageous in improving efficiencies in some embodiments.

Furthermore, if a multiple or continual remuneration policy is implemented with respect to an operating end-user a secure communications system 262/264 may enable a manufacturer, reporting bureau, governmental entity, service provider or any other notification or reporting entity 260 to validate the authenticity of communications from the powered device 250 and/or an end-user, preventing duplicative or fraudulent specification exceeding event reporting sent by a reporting party in order to receive rewards not legitimately earned. Without a secure communications system a consumer may fraudulently implement a multiple remuneration scheme by replaying violation transmissions and claiming improper and unwarranted remuneration, and thus secure communications systems 262/264 may provide advantages in minimizing or eliminating fraud by verifying reporting entity identification and reporting channels.

In some embodiments, secure communications are accomplished through associating a public key with the powered device manufacturer and a hashed version of the serial number of the device, wherein the public key may be used to encrypt a one-time message that provides privacy of the message and a hashed value of the serial number to provide authenticity to the manufacturer. A two-way communication network 262/264 may also be established or maintained for the reporting violations, with the party receiving the report sending back an encrypted secret seed for a next subsequent report or communication. Or if a two-way network is not available, then slightly less secure mechanisms of encrypting based on a hashed combination of the serial number and the date may also be used. In another aspect, environment information may be observed and/or transmitted for consideration for power usage specification compliance for devices and appliances 250 that are environmentally sensitive; for example, air conditioners, furnace, refrigerators and computer may have different energy usage profiles over different ambient temperatures, and thus surrounding ambient air temperatures they have to be observed (in some examples by the module 200) and reported to an entity 260 in order to determine compliance with a given specification.

Comparing actual observed power usages to one or more specifications may comprise using one or more look-up tables for a given device. Look-up table entries may include variables specific to the powered device and to an operating context. Thus, monitoring a computing device for power usage may also comprise monitoring or observing the operating context of the computer device, wherein an observed power usage may be compared to a corresponding look-up table entry for an expected power usage for the same operating context, for example as incorporated within a network processing system comprising “32 processors, 4.0 GHz, 16 internal disk drives of specified size and RPM performance attribute, and with an embedded/attached monitor.” In another aspect, if environmental information is also monitored and reported, another look-up table comparison methodology may be used to determine whether the observed power usage violates an environmental or green computing standard or regulation.

Monitoring power usage (as well as operating context conditions such as ambient air temperature and other parameters) may also comprise aggregating methodology. Thus, in one example observations may be aggregated over a period of time for a given monitored device and compared to look-up table aggregated value entries with respect to the same or similar devices, and some examples further considering operating conditions (e.g. for a given number of processors and disk drives), wherein if the device or system consumes more than a permissible rated amount of power as indicated by the look-up table a warning condition notification or a remuneration event may be triggered, and further wherein data may be communicated to an aggregation center for crediting or debiting against one or more end-user, manufacturer, retailer, wholesaler, etc. credit accounts.

In another aspect, positive feedback mechanisms may include direct remuneration of monetary or other rewards of value to an operating end-user, for example in consideration for the end-user agreeing to monitor and report actual power usage data of the device, and/or to enable or facilitate a powered device monitoring component to directly report the data to another entity. Remuneration may require that certain prerequisites be met, for example remuneration may be conditional upon certain operating conditions such as time of day, correlation with green source availability, duration of excess energy consumption and environmental conditions: in one example, only excess usage observations correlated with peak power demand time periods may qualify for remuneration to the end-user. In another aspect, excess energy consumption violations may be determined from observing single fluctuations over a given threshold, or they may require a specified or determined number or frequency of fluctuations over a given threshold, or a determination that an average consumed power value over a given time period exceeds a given threshold.

Remuneration and other positive feedback provided to the end-user may comprise monetary or non-monetary rewards, and may comprise a wide variety of systems methodology, for example including one-time payments, multiple payments with a remuneration cap, multiple unlimited numbers of payments, as well as variable and dynamic remuneration schedules (for example, providing for an exponential decay or increase of payments as a function of number of reports and/or time). Remuneration amounts may relate to a number and nature of abnormal/excessive energy consumption events. For example, if a device is consuming twice the energy claimed for its maximum consumption, a remuneration service provider may pay an end-user a one-time monetary payment for the first or each time that the device consumes too much energy, for the first or each time that too much energy is consumed over a specified time period, or for the first or each time that energy is consumed outside of non-peak or green source availability period required by a usage specification. Policies for remuneration may be set and/or advertised by a device manufacturer, retailer, wholesaler, etc. Manufacturers advertising remuneration policies or conditions more advantageous to the end-user when their product uses too much energy or otherwise violates an agreed standard would communicate greater confidence in or inherent reliance of their devices to consumer end-users relative to competing device manufacturers, retailers, etc., in one aspect to achieve more device sales or improve their reputation or goodwill in the marketplace.

Remunerations may also be aggregated: in one example a reporting or monitoring bureau or service provider may aggregate the observation or collection of reports of excess energy use with respect to a powered device manufacturer over all devices manufactured, sold, in service, etc., with remuneration to any one user based upon aggregate or multiple device performance over a plurality of end users. In some embodiments, when monitoring determines that more power is used than expected through advertising or other manufacturer, retailer, etc. representations, a message may be sent to an appropriate remuneration bureau or entity, and this entity may route notification and/or associated data to other servers or service providers that may ultimately provide positive feedback or remuneration to the end-user.

Reporting of power usage and power usage specification violations may comprise providing consumption and environmental reports to a manufacturer, owner, competitor, advertisers, etc. Data may be analyzed and instructions for correcting standard violation problems may be included in positive feedback to the operating end-user, as well as to manufacturers and other parties. Such instructions may include identification of defective or worn-out device parts for replacement or service: for example, a worn-out fan may cause another device cooling fan to consume excess electricity in an attempt to compensate for the overall diminished cooling capacities of the system, as well as resulting in a higher operating environment temperature for the powered device which may further degrade power usage profiles or other operating characteristics. Feedback and third-party reports may also include conclusions and recommendations for obviating likely problems, for example reporting that a dehumidifier is in an operating environment outside its specified temperature range, and recommending steps for remedying the present unacceptable operating condition.

In another aspect, it is generally inconvenient, cumbersome, difficult or impossible under the prior art for consumers and other end-users to verify and enforce power usage and other energy performance standard performance parameters for a given device. Often manufacturer representations with respect to the performance of their devices relative to certain standards and specifications (for example, Energy Star ratings) form part of the consideration for the purchase price paid for the device by the end-user. For example, an end-user may pay more for a more-efficient device that he would pay for a less-efficient device, sometimes in order to achieve cost savings in operating the device that will compensate the purchaser for the extra price paid, and sometimes in order to reduce resource requirements in operating the device over the comparable less-efficient device (e.g., to achieve carbon-trading credits).

Some end-users may pay extra for more-efficient devices without expectation of a direct financial benefit: for example, some end-users may desire to reduce greenhouse gas emissions or otherwise cause less harm to the environment, and may thus be willing and able to pay extra for less power intensive devices without expecting a requiring a clear direct financial benefit in return. Thus, in another aspect, positive feedback provided to the monitoring user may comprise confirmation of represented power usage efficiencies, and further information indicating actual greenhouse gas emission reductions or other environmental impact reductions achieved through past, present and continuing or future operating of the monitored device relative to operating another comparable less-efficient powered device. Thus, the present application provides methods and systems that encourage end-users to monitor powered devices and appliances for compliance with the specifications as disclosed and represented by a device manufacturer, with the positive feedback mechanisms causing users to undertake the efforts and burdens needed to effectively monitor such power devices.

The present invention thus encourages and facilitates monitoring through providing compensation to the end-user when the manufacturer's device exceeds published energy consumption specification. Manufacturers, device managers, retailers and wholesalers and other device providers are also encouraged to provide an accurate power consumption specifications and representations, for example to avoid reports of excessive power usage.

In some embodiments, demonstrating compliance with such specifications may result in rewards to one or more of the providing parties; for example, manufacturers who consistently demonstrate compliance with certain standards or requirements may be rewarded with preferential designations by governmental entities for government procurement contracts, may qualify for incorporation of their devices into green computing certification programs, or may even be directly financially rewarded with monetary rewards or crediting of carbon-trading credits in one or more carbon trading accounts; other reward mechanisms for manufacturers and other device providers will be apparent to one skilled in the art.

Through improving public awareness of power and resource efficiency standards competition may also be encouraged among device manufacturers, retailers etc. to offer relatively higher power-saving devices and configurations in order to stand out from their competition and improve market share. Because such specifications will be visible. Moreover, when analyzing monitoring data results in the provision of instructions to end-users for reconfiguring or returning devices back into an expected energy usage range, the end-user they perceive a higher value of the device relative to other devices that do not offer such feedback; such embodiments further offer additional opportunities for revenue, for example by a service provider who offers to monitor device power usage and provide rewards to an end-user for engaging the monitoring service, and wherein device updating or other improvement instructional services may be provided as additional fee-based optional services (which may be paid for by the end-user as well as a manufacturer, retailer, etc.).

In another aspect, manufacturers may use methods and systems according to the present application to verify compliance with applicable standards by their competitors. In some examples, a manufacturer noting a regulatory standard violation by a competitor may report the violation to a regulatory agency, thereby enabling private industry parties to enlarge the reach and scope of monitoring and compliance actions otherwise beyond the capacities of the regulatory agency, to encompass violating activities they do not have the resources to discover without help. Monitoring and notifying mechanisms according to the present application may also provide affirmative data and information to the industry as a whole, as well as to governmental and agency regulators, in support of the efficacy and viability of newly-implemented technology and methodology, in one respect providing objective data urging movement of an entire industry in one or more new directions that are shown to provide higher power efficiency. Competition may also encourage manufacturers to continually improve their devices to stay ahead of competitors' energy consumption specifications and characteristics.

### II. Computerized Implementation

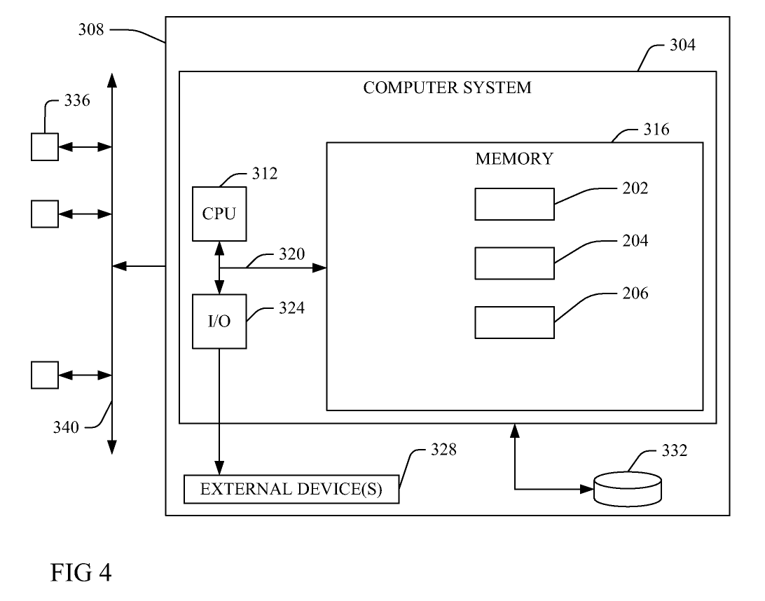

Referring now to FIG. 4, an exemplary computerized implementation includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage system 332. In general, the processing unit 312 executes computer program code, such as the code to implement various components of the process and systems, and devices as illustrated in FIGS. 1 and 2 and described above, including the power usage monitor 202, the usage comparator 204 and the reward engine 206 components discussed above, which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboard, pointing device, display, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 3 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1 and 2 above and described otherwise herein. To this extent, the computer-readable/useable medium includes program code that implements each of the various process steps of the present application.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for effecting compliance with power usage specifications through positive feedback to a monitoring entity, comprising:
providing a power usage specification for a device for a task performed by the device;
using the device to perform the task;
monitoring power used by the device to perform the task to generate power usage data;
comparing the power usage data to the power usage specification; and
if the power usage data exceeds the power usage specification, a reward entity automatically providing a reward to a device end-user selected as a function of a value of the specification exceeding and an agreement with the end-user or a third party.

2. The method of claim 1, further comprising at least one of:
the power usage specification comprising a predicted power usage value for the device to perform the task, the monitoring comprising observing an actual power usage of the device required to perform the task, the power usage data exceeding the power usage specification comprising the observed actual power usage exceeding the predicted power usage value; and
the power usage specification comprising a requirement for the device to perform the task during a first power rate period, the first power rate period having a lower energy or resource cost than a second power rate period, the monitoring comprising observing the device performing the task within a one of the first rate period and the second rate period, and the power usage data exceeding the power usage specification comprising observing the device performing the task during the second rate period.

3. The method of claim 2 wherein the power usage specification comprises at least one of:
a maximum allowable power usage value defined relative to a first defined period of time; and
an average allowable power usage value defined relative to a second defined period of time.

4. The method of claim 3, wherein the comparing comprises considering power consumption data from a time period different from a time period of the observing of the power usage data, or comparing a power consumption reported from another device.

5. The method of claim 2, further comprising setting the reward as a function of an amount of the power usage data exceeding the power usage specification.

6. The method of claim 5, further comprising providing a notification reward to the device end-user for the end-user notifying a supervisory entity of the power usage data exceeding the power usage specification.

7. The method of claim 6, the providing a reward to the device end-user comprising setting a reward amount as a function of a history of continuous or additional monitoring by the end-user.

8. The method of claim 2, further comprising:
the end-user or a device power usage monitor component communicating with the reward entity through a secure communications means; and
the reward entity validating a reporting of the power usage data exceeding the power usage specification and providing the reward as a function of receiving the reporting through the secure communications means.

9. The method of claim 2, further comprising:
analyzing the power usage data to determine a device configuration revision for reducing the power used by the device to perform the task; and
communicating the device configuration revision to the end-user for implementation in the device; or
directly revising a device configuration responsive to the determined device configuration revision.

10. The method of claim 9, further comprising ascertaining an environmental operating context of the device, wherein at least one of the comparing and the analyzing is a function of the ascertained environmental operating context.

11. A service for effecting compliance with power usage specifications through positive feedback to a monitoring entity, comprising:
a monitoring entity providing a computational device infrastructure configured to monitor power used by a device to perform a task as function of a power usage specification for the device to perform the task, thereby generating power usage data;
the monitoring entity using the computational device infrastructure to:
monitor power used by the device to perform the task;
compare the power usage data to the power usage specification; and
if the power usage data exceeds the power usage specification, automatically provide a reward to a device end-user selected as a function of a value of the specification exceeding and an agreement with the end-user or a third party.

12. The service of claim 11, further comprising at least one of:
providing a predicted power usage value for the device to perform the task as the power usage specification, the monitoring comprising observing an actual power usage of the device required to perform the task, the power usage data exceeding value comprising an amount of the observed actual power usage exceeding the predicted power usage value; and
providing a requirement for the device to perform the task during a first power rate period as the power usage specification, the first power rate period having a lower energy or resource cost than a second power rate period, the monitoring comprising observing the device performing the task within a one of the first rate period and the second rate period, and the power usage data exceeding the power usage specification comprising observing the device performing the task during the second rate period.

13. The service of claim 12, further comprising defining the power usage specification by at least one of:
a maximum allowable power usage value defined relative to a first defined period of time; and
an average allowable power usage value defined relative to a second defined period of time.

14. The service of claim 13, further comprising setting the reward as a function of an amount of the power usage data exceeding the power usage specification.

15. The service of claim 14, further comprising providing a notification reward to the device end-user for the end-user notifying a supervisory entity of the power usage data exceeding the power usage specification.

16. The service of claim 15, further comprising:
analyzing the power usage data to determine a device configuration revision for reducing the power used by the device to perform the task; and
communicating the device configuration revision to the end-user for implementation in the device; or
directly revising a device configuration responsive to the determined device configuration revision.

17. A method for effecting compliance with power usage specifications through positive feedback to a monitoring entity, comprising:
producing computer executable program code;
storing the code on a computer readable medium;
providing the program code to be deployed and executed on a computer system, the program code causing the computer system to:
monitor power used by a device to perform a task as function of a power usage specification for the device to perform the task, thereby generating power usage data;
compare the power usage data to the power usage specification; and
if the power usage data exceeds the power usage specification, automatically provide a reward to a device end-user selected as a function of a value of the specification exceeding and an agreement with the end-user or a third party.

18. The method of claim 17, the program code comprising instructions which, when executed on the computer system, causes the computer system to perform at least one of:
wherein the power usage specification comprises a predicted power usage value for the device to perform the task, monitor by observing an actual power usage of the device required to perform the task, and determine an amount of the observed actual power usage data exceeding the predicted power usage value; and
wherein the power usage specification comprises a requirement for the device to perform the task during a first power rate period, the first power rate period having a lower energy or resource cost than a second power rate period, monitor by observing the device performing the task within a one of the first rate period and the second rate period, and determine the power usage data exceeding the power usage specification by observing the device performing the task during the second rate period.

19. The method of claim 18, the program code comprising instructions which, when executed on the computer system, causes the computer system to compare by considering power consumption data from a time period different from a time period of the observing of the power usage data, or comparing a power consumption reported from another device.

20. The method of claim 18, the program code comprising instructions which, when executed on the computer system, causes the computer system to:
analyze the power usage data to determine a device configuration revision for reducing the power used by the device to perform the task; and
communicate the device configuration revision to the end-user for implementation in the device; or
directly revise a device configuration responsive to the determined device configuration revision.

21. A programmable device comprising:
a processing means;
a memory in communication with the processing means comprising a logic component; and
a network interface in communication with the processing means and the memory;
wherein the processing means is configured to:
monitor power used by a device to perform a task as function of a power usage specification for the device to perform the task, thereby generating power usage data;
compare the power usage data to the power usage specification; and
if the power usage data exceeds the power usage specification, automatically provide a reward to a device end-user selected as a function of a value of the specification exceeding and an agreement with the end-user or a third party.

22. The programmable device of claim 21, further configured to, at least one of:
wherein the power usage specification comprises a predicted power usage value for the device to perform the task, monitor by observing an actual power usage of the device required to perform the task, and determine an amount of the observed actual power usage data exceeding the predicted power usage value; and
wherein the power usage specification comprises a requirement for the device to perform the task during a first power rate period, the first power rate period having a lower energy or resource cost than a second power rate period, monitor by observing the device performing the task within a one of the first rate period and the second rate period, and determine the power usage data exceeding the power usage specification by observing the device performing the task during the second rate period.

23. The programmable device of claim 22, further configured to analyze the power usage data to determine a device configuration revision for reducing the power used by the device to perform the task; and
communicate the device configuration revision to the end-user for implementation in the device; or
directly revise a device configuration responsive to the determined device configuration revision.

24. The programmable device of claim 22, further configured to provide a reward to the device end-user by setting a reward amount as a function of a history of continuous or additional monitoring by the end-user.

25. The programmable device of claim 24, further configured to communicate with the reward entity and the end-user through a secure communications means; and
validate a report of the power usage data exceeding the power usage specification and provide the reward as a function of receiving the reporting through the secure communications means.
